(19) United States
(12) Patent Application Publication
(10) Pub. No.: US 2016/0293376 A1
(43) Pub. Date: Oct. 6, 2016

(54) TRAVELING WAVE TUBE

(71) Applicant: NEC Network and Sensor Systems, Ltd., Tokyo (JP)

(72) Inventor: Takashi NAKANO, Tokyo (JP)

(73) Assignee: NEC Network and Sensor Systems, Ltd.

(21) Appl. No.: 14/868,522

(22) Filed: Sep. 29, 2015

(30) Foreign Application Priority Data
Mar. 30, 2015 (JP) 2015-068459

(51) Int. Cl. H01J 23/24; H01J 25/34

(52) U.S. Cl. CPC H01J 23/24; H01J 25/34

(57) ABSTRACT

When a plurality of amplifiers for transmission source are used, a related traveling wave tube requires a large space for arranging a plurality of the traveling wave tubes. In this respect, a traveling wave tube of an exemplary embodiment of the present invention includes two meander-shaped waveguides formed to have the same meander pitch, wherein the meander-shaped waveguides are assembled together such that beam holes of one of the meander-shaped waveguides and those of the other one are arranged on the same axis, and one of the meander-shaped waveguides is shifted with respect to the other one by a quarter folding period in the wave traveling direction.

This application is based upon and claims the benefit of priority from Japanese Patent Application No. 2015-068459, filed on Mar. 30, 2015, the disclosure of which is incorporated herein in its entirety by reference.

### TECHNICAL FIELD

The present invention relates to a traveling wave tube, and in particular, to a waveguide.

### BACKGROUND ART

Traveling wave tubes are mainly used as amplifiers for transmission sources in radio systems such as those for satellite communications, radars.

Traveling wave tubes have higher breakdown voltages than that of amplifiers employing semiconductor devices and are capable of high power amplification. That is, traveling wave tubes are favorable for amplifiers for transmission sources in radio systems, such as those for satellite communications and radars, where high power operation is required. For this reason, even in recent years where size reduction and integration of electrical circuits have been advancing, traveling wave tubes whose sizes are large in comparison with that of electrical circuits are still used.

Traveling wave tubes amplify a radio frequency wave for transmission by causing it to interact with a beam of electrons which works as an energy source. In causing the interaction, the radio frequency wave is made to take a roundabout route so that it comes to have about the same speed as that of the electron beam. It may be called wave slowing. As a method for making the radio frequency wave take a roundabout route, there is a method of using a traveling wave tube referred to as the helix type one in which the radio frequency wave is propagated in a helix-shaped waveguide and the electron beam is passed along the central axis of the waveguide.

Presently, increase in frequency for wireless communications is being advanced, and development of wireless devices for the terahertz region is being conducted. In the terahertz region, development of various types of sensing technologies and the like also has been advanced in recent years. In association with such situation, there is demand for development of an amplifier for transmission source in the terahertz region.

With the increase in frequency from the microwave region to the terahertz region, the wavelength becomes smaller. Accordingly, the helix type traveling wave tube becomes difficult to manufacture, because it becomes necessary to reduce the size of a helix-shaped wiring of the waveguide. Therefore, a folded waveguide type traveling wave tube is said to be promising in the terahertz region, instead of the helix type one. The folded waveguide type one has a configuration in which a radio frequency wave is slowed down by being passed through a meander-shaped waveguide and a beam of electrons passes along the central axis of the waveguide. Non-patent Literature 1 describes a research result on a traveling wave tube of the folded waveguide type. Particularly in a higher frequency side of the terahertz region, the meander-shaped waveguide may be fabricated by the on-chip MEMS (Micro Electro Mechanical Systems) technology.

In radio systems such as those for satellite communications and radars, there may be cases requiring high power, for performing simultaneous wireless communications with a plurality of sites, sensing with respect to a plurality of sites, and the like. In those cases, it may occur that the power is insufficient with only a single amplifier for transmission source, and accordingly, a plurality of amplifiers for transmission source are used.

### CITATION LIST

### Non-Patent Literature

[Non-patent Literature 1] IEEE Transactions on Plasma Science, Vol. 39, No. 8, August 2011

### SUMMARY OF INVENTION

### Technical Problem

However, in the above-described case where a plurality of amplifiers for transmission source are used, a large space is required for arranging a plurality of traveling wave tubes.

The objective of the present invention is to provide a traveling wave tube which can solve the above-described problem in that a large space is required for arranging a plurality of traveling wave tubes.

### SUMMARY

A traveling wave tube of the present invention includes two meander-shaped waveguides formed to have the same meander pitch, wherein the meander-shaped waveguides are assembled together such that beam holes of one of the meander-shaped waveguides and those of the other one of the meander-shaped waveguides are arranged on the same axis, and one of the meander-shaped waveguides is shifted with respect to the other one by a quarter folding period in the wave traveling direction.

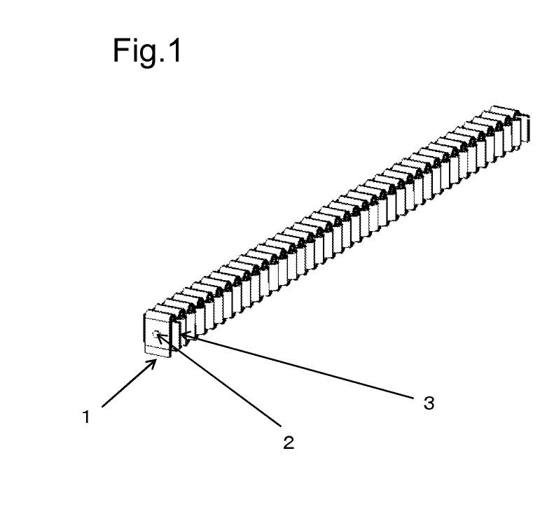

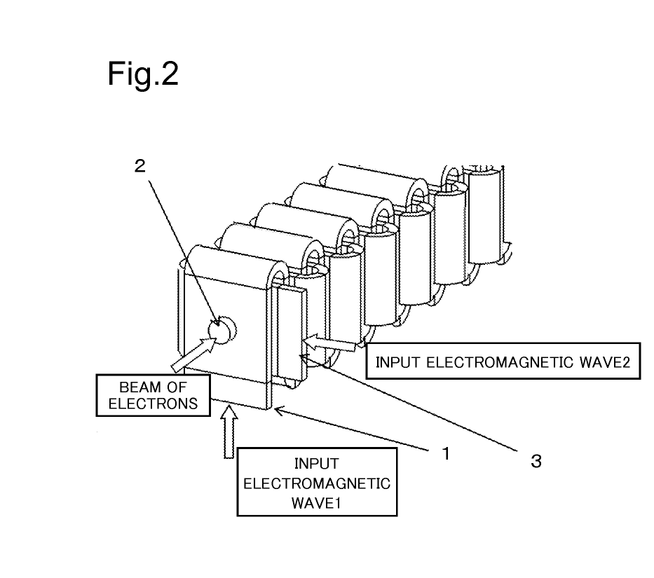

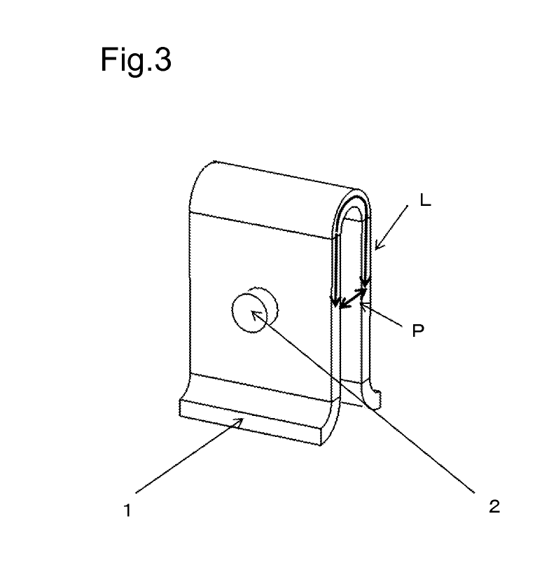

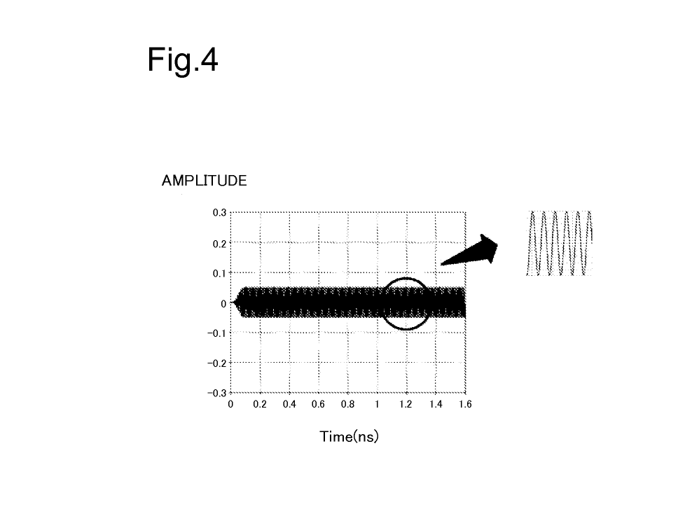

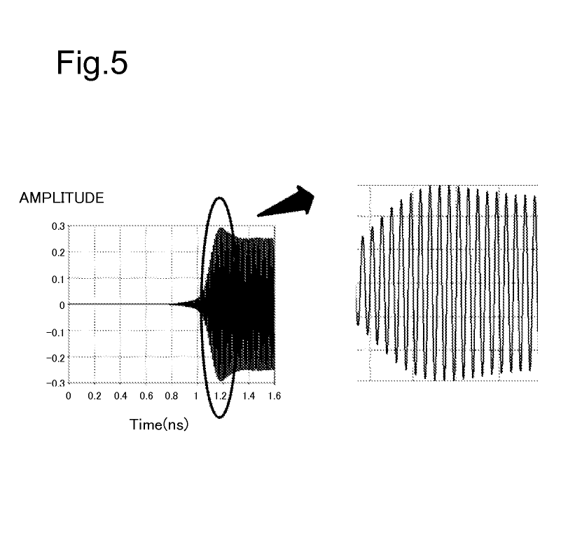

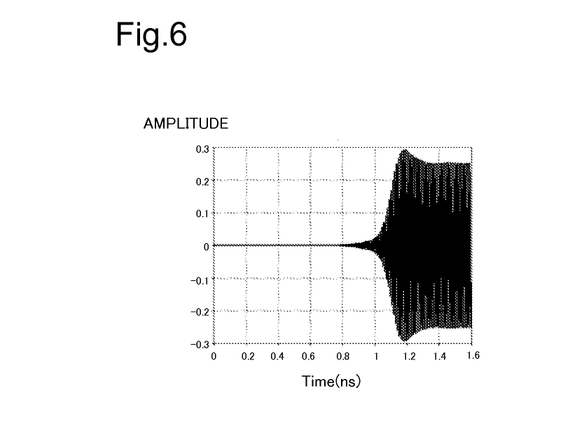

### BRIEF DESCRIPTION OF THE DRAWINGS

[FIG. 1] An overall view showing an internal structure of a traveling wave tube according to an exemplary embodiment of the present invention

[FIG. 2] A partial expanded view showing the internal structure of the traveling wave tube according to the exemplary embodiment of the present invention

[FIG. 3] A diagram showing a structure for a single folding period of a meander-shaped waveguide according to the exemplary embodiment of the present invention

[FIG. 4] A diagram showing a waveform of an input electromagnetic wave in the exemplary embodiment of the present invention

[FIG. 5] A diagram showing a waveform of an output electromagnetic wave from one of meander-shaped waveguides according to the exemplary embodiment of the present invention

[FIG. 6] A diagram showing a waveform of an output electromagnetic wave from the other one of the meander-shaped waveguides according to the exemplary embodiment of the present invention

### EXEMPLARY EMBODIMENT

Hereinafter, an exemplary embodiment of the present invention will be described in detail, with reference to drawings. In the following description, there may be a case where the same sign is assigned to constituent elements having the same function, and their description is not duplicated.

### Configuration

FIG. 1 is an overall view showing an example of an internal structure of a traveling wave tube according to an exemplary embodiment of the present invention. FIG. 2 is a partial expanded view showing the internal structure of the traveling wave tube according to the exemplary embodiment of the present invention. In FIG. 2, a meander-shaped waveguide 3 is assembled with another meander-shaped waveguide 1 such that it is rotated by 90 degrees around the central axis of beam holes 2 and shifted by a quarter folding period in the wave traveling direction, both with respect to the meander-shaped waveguide 1, and its beam holes 2 are located on the same axis as that of the beam holes 2 of the meander-shaped waveguide 1. The meander-shaped waveguide 1 is a path for a radio frequency wave, and the beam holes 2 constitute a path for a beam of electrons. The rotation angle does not necessarily need to be 90 degrees, but may be, for example, 45 degrees or 60 degrees, or may also be any other angles. The meander-shaped waveguide 3 may be assembled with the meander-shaped waveguide 1 in an alternative manner where, for example, with its beam holes 2 being located on the same axis as that of the beam holes 2 of the meander-shaped waveguide 1, it is rotated within the vertical plane by an angle between 0 and 180 degrees around the axis. The meander-shaped waveguide 3 may be assembled with the meander-shaped waveguide 1 in a further alternative manner where, for example, with its beam holes 2 being located on the same axis as that of the beam holes 2 of the meander-shaped waveguide 1, it is shifted with respect to the meander-shaped waveguide 1 by a period between 0 and a half folding period in the wave traveling direction.

FIG. 3 is a diagram showing an example of a structure for a single folding period of the meander-shaped waveguide according to the exemplary embodiment of the present invention. In FIG. 3, the waveguide length corresponding to the single folding period is Lx2=6.64 mm, and the axial length corresponding to the single folding period is Px2=1.48 mm. The length P may be referred to as the meander pitch. In the present exemplary embodiment, one meander-shaped waveguide is constructed by repeatedly arranging 73 periods of the structure of FIG. 3. Then, by assembling together two meander-shaped waveguides formed to have the same meander pitch, one folded waveguide type traveling wave tube is constructed, in the present exemplary embodiment. In an alternative exemplary embodiment, the meander pitch may be different between the two meander-shaped waveguides. For example, the meander pitch of one of the waveguides may be a multiple of that of the other one. That is, the meander pitches of the two waveguides may be any values which enable fitting together the two waveguides.

FIGS. 1, 2 and 3 are diagrams showing the structure inside the traveling wave tube, whose surroundings are actually covered with a conductor such as Cu.

### Operation

FIG. 4 is a diagram showing a waveform of an input electromagnetic wave in the exemplary embodiment of the present invention. FIG. 5 is a diagram showing a waveform of an output electromagnetic wave from one of the meander-shaped waveguides according to the exemplary embodiment of the present invention. FIG. 6 is a diagram showing a waveform of an output electromagnetic wave from the other one of the meander-shaped waveguides according to the exemplary embodiment of the present invention. In the both diagrams, the horizontal axis represents the elapsed time since the start of measurement.

As shown in FIG. 4, the input amplitude is 0.05. As shown in FIGS. 5 and 6, the output amplitude is about 0.25 for both of the meander-shaped waveguides. That is, a gain of about 14 dB is obtained for the both meander-shaped waveguides. This value shows no difference from that in the characteristic of each of the meander-shaped waveguides before being assembled with the other one. That is, with the single traveling wave tube of the present exemplary embodiment, it is possible to obtain an output equal to the total output of the two meander-shaped waveguides before being assembled together.

As measurement conditions, the electron beam voltage is 12.5 kV, and the electric current is 30 mA. Because the electromagnetic waves are slowed down by making them pass through the meander-shaped waveguides each having a sufficient length, it takes a comparatively long time since the input until the output. It also takes time until the outputs become stable. The gain was calculated at a point of time which is 1.6 ns after the start of measurement.

### Advantageous Effects

According to the exemplary embodiment of the present invention, it is possible to solve the problem in that a large space is required for arranging a plurality of traveling wave tubes.

It is also possible to increase the efficiency of electron beam energy because two waveguides can be driven by a single beam of electrons.

As a fabrication method, there is one where the two meander-shaped waveguides are separately fabricated and subsequently assembled together. In this method, for example, two meander-shaped waveguides having holes to be used as the beam holes are fabricated, the two meander-shaped waveguides are bonded together in a state where a dummy beam hole metal cylinder is inserted in the holes, and then the dummy cylinder is removed. There also is a method of fabricating at one time a structure in which the two meander-shaped waveguides are already assembled together. Methods which can be considered as that kind of ones include, for example, a method of sequentially laminating metals to be the outer walls, and a method of fabricating first a core portion, evaporating metal layers onto the core portion, and then removing the core portion. Application of the on-chip MEMS technology or a three-dimensional printer also can be considered.

It is obvious that the present invention is not limited to the above-described exemplary embodiment, but various modifications thereof may be made within the scope of the invention described in the appended claims, and such modifications also are embraced within the scope of the present invention.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

### REFERENCE SIGNS LIST

1 meander-shaped waveguide
2 beam hole
3 meander-shaped waveguide

1. A traveling wave tube comprising two meander-shaped waveguides formed to have the same meander pitch, wherein
the two meander-shaped waveguides are assembled together such that:
beam holes of one of the two meander-shaped waveguides and those of the other one are arranged on the same axis; and
one of the two meander-shaped waveguides is shifted with respect to the other one by a quarter period in the wave traveling direction.

2. The traveling wave tube according to claim 1, wherein
the two meander-shaped waveguides are assembled together such that one of them is rotated with respect to the other one by 90 degrees around the axis of the beam holes.
